(19) United States
(12) Patent Application Publication
(10) Pub. No.: US 2005/0165941 A1
(43) Pub. Date: Jul. 28, 2005

(54) Methods and apparatuses for streaming content

(76) Inventors: Edward Eytchison, Milpitas, CA (US); Nisha Srinivasan, Santa Clara, CA (US)

Correspondence Address: Valley Oak Law, #106, 5655 Silver Creek Valley Road, San Jose, CA, 95138, US

(21) Appl. No.: 10/763,868

(22) Filed: Jan. 22, 2004

(51) Int. Cl. G06F 15/16

(52) U.S. Cl. 709/231; 709/217

(57) ABSTRACT

Methods and apparatuses for streaming content are described for presenting the content such that a delay time between requesting the content and utilizing the content is minimized. In one embodiment, methods and apparatuses for streaming content store an initial portion a selected content item within a temporary storage cache; stream the initial portion of the selected content from the temporary storage cache to a stream synchronizer; simultaneously load an entire segment of the selected content to the stream synchronizer while streaming the initial portion; produce a resultant stream comprising the initial portion of the selected content; and seamlessly transition the resultant stream from the initial portion of the content to the entire segment of the content.

### FIELD OF INVENTION

The present invention relates generally to delivering content and, more particularly, to delivering content while minimizing delays.

### BACKGROUND

With the proliferation of computer networks, in particular the Internet, there is an increasing number of commercially available audio/visual content directed for use by individual users. Further, there are a variety of ways to create audio/visual content using, e.g., video cameras, still cameras, audio recorders, and the like. There are also many applications available to modify and/or customize audio/visual content.

Individual users have a large number of audio/visual content items available to view, modify, and/or create. With the increased popularity of audio/visual content, there has also been an increase in the quality of and new functionality in audio/visual content. Accordingly, there has also been an increase in the file size of audio/visual content items. Hence, storing high quality video content consumes a considerable amount of storage media.

In addition to the challenges of storing large files containing audio/visual content, there are also challenges in distributing large files containing audio/visual content to remote devices through a network such as the Internet.

Due to bandwidth and timing constraints, a user may experience a considerable delay between requesting audio/visual content and receiving the audio/visual content.

### SUMMARY

Methods and apparatuses for streaming content are described for presenting the content such that a delay time between requesting the content and utilizing the content is minimized. In one embodiment, methods and apparatuses for streaming content store an initial portion a selected content within a temporary storage cache; stream the initial portion of the selected content from the temporary storage cache to a stream synchronizer; simultaneously load an entire segment of the selected content to the stream synchronizer while streaming the initial portion; produce a resultant stream comprising the initial portion of the selected content; and seamlessly transition the resultant stream from the initial portion of the content to the entire segment of the content.

### BRIEF DESCRIPTION OF THE DRAWINGS

The accompanying drawings, which are incorporated in and constitute a part of this specification, illustrate and explain embodiments of the methods and apparatuses for streaming content. In the drawings,

FIG. 1 is a diagram illustrating an environment within which the methods and apparatuses for streaming content are implemented.

FIG. 2 is a simplified block diagram illustrating one embodiment in which the methods and apparatuses for streaming content are implemented.

FIG. 3 is a simplified block diagram illustrating an exemplary architecture of the methods and apparatuses for streaming content.

FIG. 4 is a simplified block diagram illustrating an exemplary architecture of the methods and apparatuses for streaming content.

FIG. 5 is a simplified block diagram illustrating an exemplary embodiment of classes in which the methods and apparatuses for streaming content are implemented.

FIG. 6 is a simplified block diagram illustrating an exemplary media container system of the methods and apparatuses for streaming content.

FIG. 7 is a flow diagram illustrating a content delivery process, consistent with one embodiment of the methods and apparatuses for streaming content.

FIG. 8 is a flow diagram illustrating a content delivery process, consistent with one embodiment of the methods and apparatuses for streaming content.

### DETAILED DESCRIPTION

The following detailed description of the methods and apparatuses for streaming content refers to the accompanying drawings. The detailed description illustrates embodiments of the methods and apparatuses for streaming content and is not intended to construct limitations. Instead, the scope of the invention is defined by the claims.

Those skilled in the art will recognize that many other implementations are possible and are consistent with the methods and apparatuses for streaming content.

References to “content” includes data such as audio, video, text, graphics, and the like, that are embodied in digital or analog electronic form. References to “applications” includes user data processing programs for tasks such as word processing, audio output or editing, video output or editing, digital still photograph viewing or editing, and the like, that are embodied in hardware and/or software.

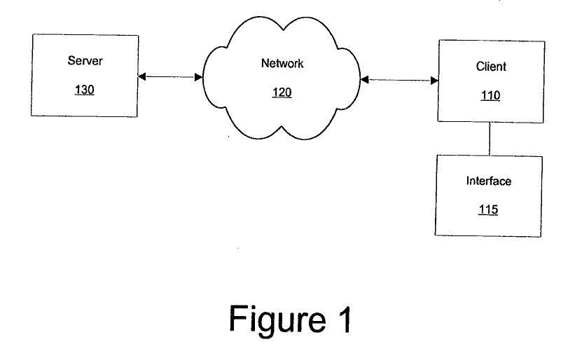

FIG. 1 is a diagram illustrating an environment within which the methods and apparatuses for streaming content are implemented. The environment includes an electronic device 110 (e.g., a computing platform configured to act as a client device, such as a personal computer, a personal digital assistant, a cellular telephone, a paging device), a user interface 115, a network 120 (e.g., a local area network, a home network, the Internet), and a server 130 (e.g., a computing platform configured to act as a server).

In some embodiments, one or more user interface 115 components are made integral with the electronic device 110 (e.g., keypad and video display screen input and output interfaces in the same housing as personal digital assistant electronics (e.g., as in a Clie® manufactured by Sony Corporation). In other embodiments, one or more user interface 115 components (e.g., a keyboard, a pointing device (mouse, trackball, etc.), a microphone, a speaker, a display, a camera) are physically separate from, and are conventionally coupled to, electronic device 110. The user uses interface 115 to access and control content and applications stored in electronic device 110, server 130, or a remote storage device (not shown) coupled via network 120.

In accordance with the invention, embodiments of presenting streaming as described below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

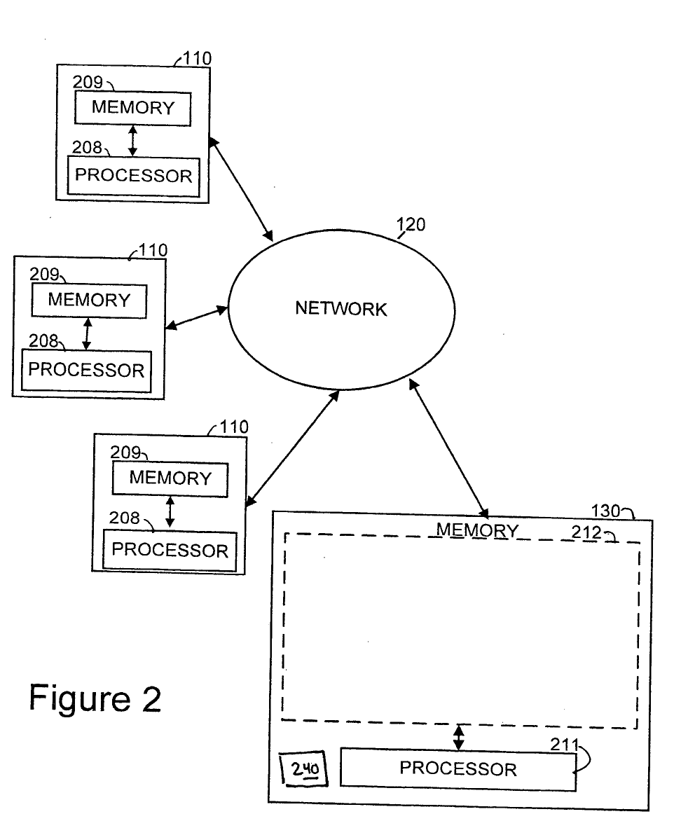

FIG. 2 is a simplified diagram illustrating an exemplary architecture in which the methods and apparatuses for streaming content are implemented. The exemplary architecture includes a plurality of electronic devices 110, server 130, and network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. A unique user operates each electronic device 110 via an interface 115 as described with reference to FIG. 1.

Server 130 includes a processor 211 coupled to a computer-readable medium 212. In one embodiment, the server 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

One or more user applications are stored in media 209, in media 212, or a single user application is stored in part in one media 209 and in part in media 212. In one instance a stored user application, regardless of storage location, is made customizable based on streaming content as determined using embodiments described below.

The plurality of client devices 110 and the server 130 include instructions for a customized application for streaming content. In one embodiment, the plurality of computer-readable media 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

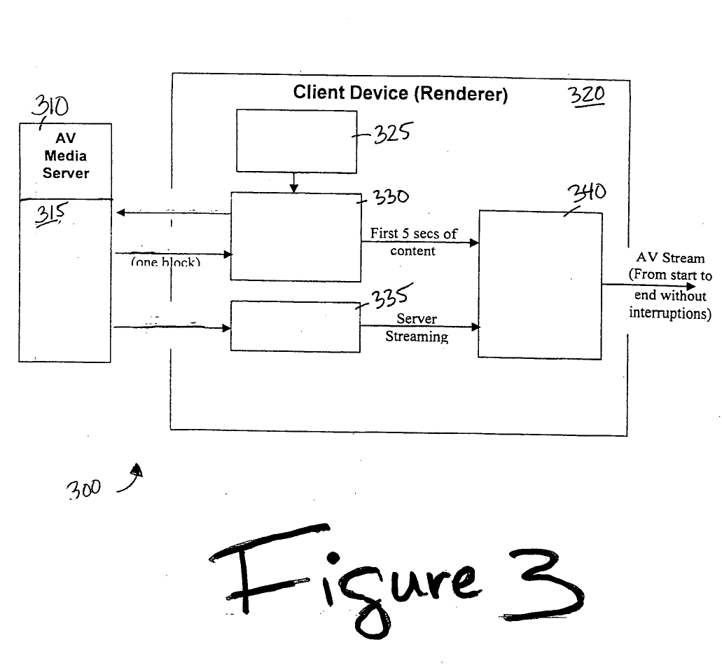

FIG. 3 is a simplified diagram illustrating an exemplary architecture of a system 300. In one embodiment, the system 300 allows a user to view audio/visual content through the system 300. The system 300 includes a media server 310 and a client device 320 in one embodiment. In one embodiment, the media server is the server 130, and the client device is the device 110.

The media server 310 and the client device 320 are configured to communicate with each other. In one instance, the media server 310 and the client device 320 are coupled and communicate via a network such as the Internet.

In some embodiments, the media server 310 organizes and stores audio/visual content. For example, in one instance, the audio/visual content is stored within a media container 315. The media container 315 is described in further detail below. Although a single media container 315 is shown in this example, any number of media containers can be utilized to store audio/visual content within the media server 310.

In one embodiment, the client device 320 receives audio/visual content from the media server 310 and outputs the received content to a client device 320 user. In some embodiments, the client device 320 presents the audio/visual content to the user in a seamless manner while minimizing delay time in displaying content.

In one embodiment, the client device 320 includes a preference data module 325, a temporary storage cache 330, a stream buffer 335, and a stream synchronizer 340. In one embodiment, the preference data module 325 contains preferences and usage patterns that are unique to the particular user of the client device 320. For example, in one instance, the preference data module 325 contains a play list representing specific audio/visual content that the user has utilized in the past.

In one embodiment, the temporary storage cache 330 is configured to temporarily store an initial portion of selected audio/visual content. In one instance, the selected audio/visual content is chosen based on the preference data module 325 and the play lists associated with a corresponding user. In one embodiment, the initial portion of the selected group of audio/visual content is stored in the temporary storage cache 330 prior to a request from the user. In this instance, storing the initial portion prevents substantial delays from occurring when the user requests any content identified within the selected group of audio/visual content. In one instance, the initial portion of the selected group of audio/visual content originates from the media server 310.

In some embodiments, the initial portion of the selected audio/visual content contains the first 5 seconds of the audio/visual content. In other embodiments, the initial portion may include any amount of audio/visual content.

In one embodiment, the stream buffer 335 serially streams an entire audio/visual content item. For example, in one instance an audio/visual content item is requested by the user. In response to this request, the requested audio/visual content item is streamed through the stream buffer 335 from the media server 310.

In one embodiment, the stream synchronizer 340 coordinates the entire stream of audio/visual content from the stream buffer 335 and the initial portion of the audio/visual content from the temporary storage cache 330. For example, in one instance the stream synchronizer 340 begins transmitting the audio/visual stream of the content with the initial portion of the audio/visual content from the temporary storage cache 330 prior to receiving the entire stream of audio/visual content from the stream buffer 335.

In one embodiment, the stream synchronizer 340 seamlessly transitions from the initial portion to the entire stream and simultaneously produces a resultant audio/visual stream that mirrors the entire stream and is without interruptions. In this instance, the stream synchronizer 340 begins producing a resultant audio/visual stream by utilizing the initial portion stored within the temporary storage cache 330 and without waiting for a first portion of the entire stream to be received through the stream buffer 335.

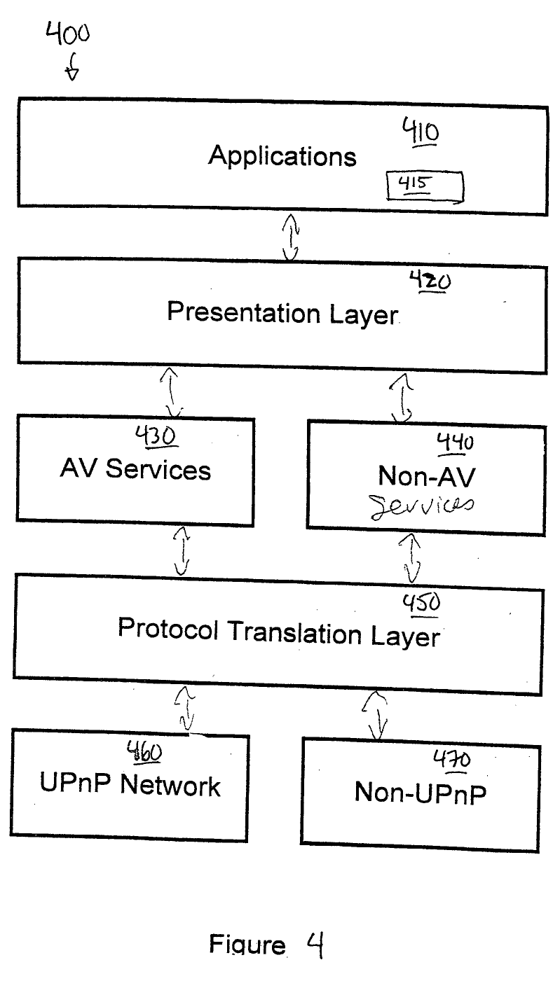

FIG. 4 is a simplified diagram illustrating an exemplary architecture of a system 400. In one embodiment, the system 400 includes applications 410, a presentation layer 420, an audio/visual services module 430, a non-audio/visual services module 440, a protocol translation layer 450, a universal plug and play (e.g. UPnP) network 460, and a non-universal plug and play network 470. Overall, the system 400 is configured to allow the applications 410 to seamlessly interface through the network 460 and the network 470.

In some embodiments, the applications 410 are utilized by a user. In one embodiment, the user is a content developer who creates and/or modifies content for viewing by others. In another embodiment, the user is a content viewer who consumes the available content by accessing the content. In some embodiments, the applications 410 include a prefetch buffer 415 for storing content that is prefetched for use by the content viewer and/or the content developer.

In some embodiments, the presentation layer 420 processes the content information in a suitable format for use by the applications 410. In one instance, the presentation layer 420 takes into account the preferences and use patterns of the particular user. In one embodiment, audio/visual content is pre-sorted according the use patterns of the user. In another embodiment, the audio/visual content is pre-fetched according to the use patterns of the user.

In one embodiment, the presentation layer 420 is configured as a shared library. By utilizing the shared library, the application code is condensed into a smaller size, because multiple applications 410 utilize the same shared library for various commands and instructions.

In some embodiments, the audio/visual service module 430 stores and maintains a representation of device information for devices that correspond to audio/visual services. In one example, audio/visual services include media classifications such as music, videos, photos, graphics, text, documents, and the like. In another example, the audio/visual service module 430 is also configured to store and maintain listings or indices of the audio/visual content that are stored in a remote location.

In one embodiment, the storage locations for the audio/visual content is organized according to the use patterns of the particular user. For example, audio/visual content that is utilized more frequently is stored in locations more quickly accessible to the system 400.

In one embodiment, the non-audio/visual service module 440 stores and maintains a representation of device information for devices that correspond to non-audio/visual services. Non-audio/visual services includes printing services, faxing services, and the like. In another embodiment, the non-audio/visual service module 440 also stores and maintains listings or indices of the non-audio/visual content that are stored in a remote location.

In some embodiments, the protocol translation layer 450 translates at least one underlying protocol into a common application programming interface suitable for use by the applications 410, the presentation layer 420, the audio/visual service module 430, and/or the non-audio/visual service module 440. For example, the protocol translation layer 450 translates the UPnP protocol from the UPnP network 460 into the common application programming interface. In one embodiment, the protocol translation layer 450 handles the translation of a plurality of protocols into the common application programming interface.

In some embodiments, the protocol translation layer 450 supports more than one network protocol. For example, the protocol translation layer 450 is capable of storing more than one translation modules for translating commands in another protocol into the common application programming interface.

In other embodiments, the protocol translation layer 450 retrieves an appropriate translation module in response to the protocol to be translated. For example, the appropriate translation module resides in a remote location outside the system 400 and is retrieved by the protocol translation layer 450.

In one embodiment, the translation modules are stored within the protocol translation layer 450. In another embodiment, the translations modules are stored in a remote location outside the system 400.

In one embodiment, the UPnP network 460 is configured to utilize a protocol established by UPnP.

In one embodiment, the non-UPnP network 470 is configured to utilize a protocol established outside of UPnP. For example, Samba and Server Message Block are protocols which are not related to UPnP.

In one embodiment, the system 400 is shown with the applications 410 logically connected to the presentation layer 420; the presentation layer 420 logically connected to the audio/visual services module 430 and the non-audio/visual services module 440; modules 430 and 440 connected to module 450; and the protocol translation layer 450 logically connected to the UPnP network 460 and the non-UPnP network 470.

The distinction between the UPnP network 460 and the non-UPnP network 470 is shown as one possible example for the method and apparatus for presenting content. Similarly, the distinction between the audio/visual services module 430 and the non-audio/visual services module 440 is shown as one possible example for the method and apparatus for presenting content.

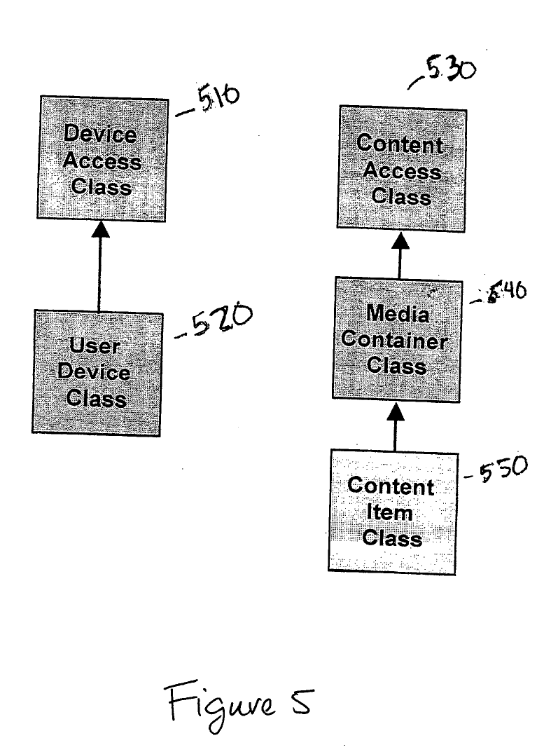

FIG. 5 is a simplified block diagram illustrating exemplary services, devices, and content organized into classes. In one embodiment, these classes are utilized by the system 400 to encapsulate and categorize information corresponding to unique content, devices, or network services relating to the presentation layer 420.

In one embodiment, the classes include both device classes and content classes. The device classes allow devices across heterogeneous networks to be managed and display of information regarding the devices. The content classes are configured to manage the audio/visual content, pre-fetch audio/visual content, and organize the audio/visual content based on user patterns.

Device classes include a device access class 510 and a user device class 520. Content classes include a content access class 530, a media container class 540, and content item class 550.

There are a variety of commands the group devices within the device access class 510. In one embodiment, the device access class 510 devices are grouped using a GetDeviceList command that retrieves a list of devices across at least one network protocol. This list of devices can be further filtered and searched based on the device type and the content type. For example, device types include audio display, video display, audio capture, video capture, audio effects, video effects, and the like. In one embodiment, content types include documents, videos, music, photo albums, and the like.

In one embodiment, the device access class 510 devices are grouped using a SetDeviceFinderCallback command that establishes a callback function when the GetDeviceList command is completed. The SetDeviceFinderCallback command can also be utilized to discover a device asynchronously.

In one embodiment, the device access class 510 devices are grouped using a GetDefaultDevice command that initializes a specific device as a default for a particular device type or content type. In one embodiment, there can be more than one default device for each type of content or device.

In one embodiment, the device access class 510 devices are organized using a Hide/ShowDevice command that either removes a device from view or exposes hidden devices.

In one embodiment, the device access class 510 devices are organized using a SortDevice command that sorts devices based on alphabetical order, device type, supported content type, and the like.

In one embodiment, the user device class 520 devices are grouped using a GetDeviceByName command that searches the entire network for a specific device. In one embodiment, the specific device is identified through a device identifier that is unique to each device, such as a device serial number. In another embodiment, the specific device is identified through a name associated with the device.

The content access class 530 assists in facilitating searches, discovery, and organization of content. In one embodiment, the content access class 530 content is grouped using a PrefetchContentList command that builds a content list based on preference information corresponding to a particular user. In one embodiment, the preference information is stored within the system 400. For example, the PrefetchContentList command is initiated when a particular user is identified. In another embodiment, the PrefetchContentList command us initiated and updated during a session with the same user. In some embodiments, prefetching content is performed based on the preferences stored within the content list.

In one embodiment, the content access class 530 content is grouped using a GetContentList command that returns a content list of content items. For example, these content items are located at addresses in multiple networks and are stored in numerous different storage devices. In one instance, these content items each come from different storage devices such as media containers.

In one embodiment, the content list is obtained in multiple segments. In another embodiment, the content list is obtained in a single segment. In one embodiment, the content list includes a reference to the location of the content and/or additional details describing the device that stores the content.

In one embodiment, the content access class 530 content is grouped using a GetContentByGenre command that retrieves content items according to a specific content genre. For example, in some instances the content items within the requested genre are located in multiple media containers.

In one embodiment, the content access class 530 content is grouped using a GetMediaContainers command that retrieves specified media containers based on a search criteria and the content within the media containers. For example, each media container is defined by a genre type or an artist. If the genre is specified, the media containers that are associated with this specified genre are identified. Further, the individual content items are also specifically identified if they are within the specified genre.

In one embodiment, the content access class 530 content is grouped using a GetDefaultGenre command which initializes specific genre as a default for a particular user. For example, content items which match the specific genre are highlighted on the content list and are prefetched from their respective media containers in response to the particular user.

The media container class 540 provides tools for managing content lists in class 530. In one instance, these content lists are managed by the media containers. In one embodiment, the media container class 540 groups media containers by a GetMediaContainerID command which allows all media containers to be referenced by a unique media container identification. This command provides the unique identification to each media container.

In one embodiment, the media container class 540 groups media containers by a GetMediaContainerName command which, in turn, allows the media container to be referenced by a descriptive name. For example, a descriptive name includes “family room music”, “home videos”, and the like.

The content class 550 provides tools for representing individual content items. In one embodiment, individual content items are represented in content lists. In one embodiment, the content class 550 content items are grouped using a GetContentID command that allows all individual content items to be referenced by a unique media content identification. This command provides the unique identification to each individual content item.

In one embodiment, the content class 550 content are grouped using a GetContentTitle command that returns the title of the individual content items.

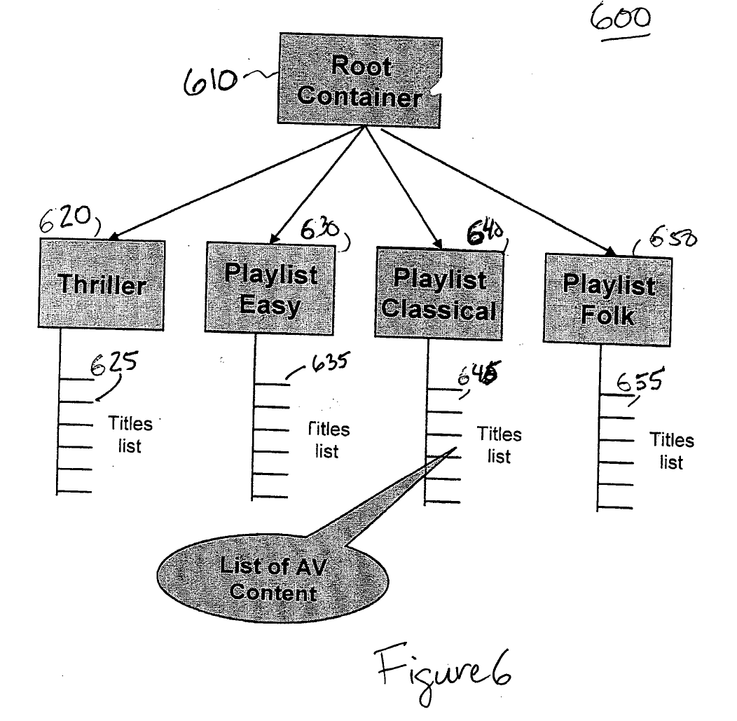

FIG. 6 is a simplified block diagram illustrating an exemplary media container system 600. In one embodiment, a media container stores content. In another embodiment, a media container stores a list representing content. In one embodiment, the media container system 600 includes a root media container 610, a thriller media container 620, an easy media container 630, a classical media container 640, and a folk media container 650. In some embodiments, the media containers allow audio/visual content to be prefetched and available for a user.

In one embodiment, the media containers 610, 620, 630, and 640 are similar to folders on a conventional computer system and are configured to link to other media containers and/or provide a representation of audio/visual content.

For example, the root media container 610 is logically connected to the thriller media container 620, the easy media container 630, the classical media container 640, and the folk media container 650. Each of the media containers 620, 630, 640, and 650 include title lists 625, 635, 645, and 655, respectively. Each title list includes a listing representing various audio/visual content.

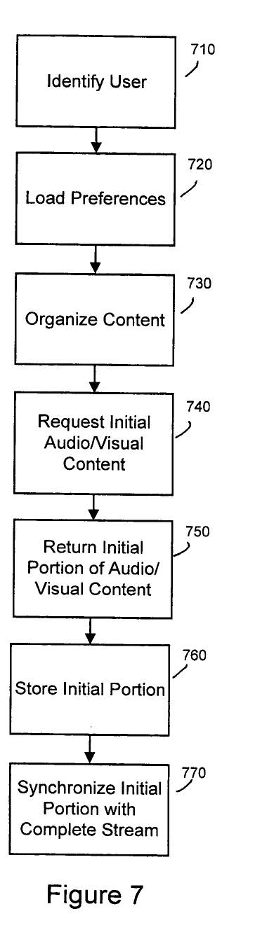

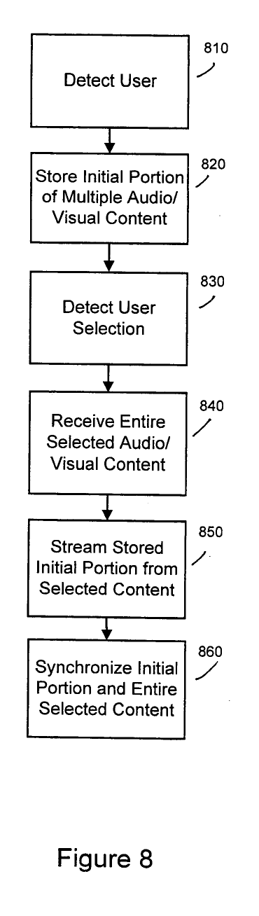

The flow diagrams as depicted in FIGS. 7 and 8 are exemplary embodiments of the invention. In each embodiment, the flow diagrams illustrate various exemplary functions performed by the system 300.

The blocks within the flow diagram may be performed in a different sequence without departing from the spirit of the invention. Further, blocks may be deleted, added, or combined without departing from the spirit of the invention.

FIG. 7 is a flow diagram that illustrates a reduced lag time content delivery process via the system 300.

In Block 710, the identity of the user is detected. In some embodiments, the identity of the user is authenticated through the use of a password, a personal identification number, a biometric parameter, and the like.

In Block 720, a preference is loaded corresponding to the user. For example, in one instance the preference includes parameters such as genre selections, and play lists. In one instance, these parameters are detected through the actions of each user. Accordingly, the preference is unique to each particular user in one embodiment. In another embodiment, the preference includes various audio/visual content items represented within playlist(s).

In Block 730, audio/visual content is organized. In one embodiment, the audio/visual content is grouped and organized according to various classes and commands which correspond with FIG. 5. In another embodiment, the audio/visual content corresponds to the play list and preferences associated with the user. For example, the audio/visual content is organized according to the highest probability of being utilized by the user as graphically shown in FIG. 6.

In Block 740, an initial portion of selected audio/visual content is requested. In some instances, the initial portion includes a variety of lengths of the initial portion of the selected audio/visual content. In one instance, the initial portion is the first 5 seconds of the selected audio/visual content.

In some embodiments, the selected audio/visual content includes audio/visual content illustrated in the preferences of the user as described within the Block 720. In other embodiments, the selected audio/visual content represents audio/visual content that will more likely be chosen by the user than other audio/visual content.

In Block 750, server 310 transmits the initial portion of the selected audio/visual content to the client device 320. In one embodiment, the selected audio/visual content resides within the media server 310.

In Block 760, the initial portion of the selected audio/visual content is stored. In one embodiment, the initial portion of the selected audio/visual content is stored within the temporary storage cache 330.

In Block 770, the initial portion of one of the selected audio/visual content is streamed in response to the user request to output one of the selected audio/visual content items. In addition, the initial portion is synchronized with an entire segment of the requested audio/visual content.

For example, in one instance the stream synchronizer 340 streams the initial portion of a corresponding selected audio/visual content from the temporary storage cache 330 immediately after the user requests this audio/visual content. Shortly thereafter, the entire segment of the requested audio/visual content is obtained and streamed via the stream buffer 335 to the stream synchronizer 340. In this instance, the stream synchronizer 340 produces a resultant stream that begins with the initial portion from the temporary storage cache 330 and is ultimately replaced by the entire segment from the stream buffer 335. In many instances, this transition between the initial portion and the entire segment is synchronized such that the transition is seamless in the resultant stream and is configured to be utilized by the user.

In some embodiments, the transition between the initial portion and the entire segment occurs in real-time. For example, in one instance, the stream synchronizer 340 utilizes the initial portion via the temporary storage cache 330 in producing the resultant stream until enough of the entire segment from the stream buffer 335 is received by stream synchronizer 340 for a seamless transition.

FIG. 8 is a second flow diagram that illustrates a reduced lag time content delivery process via the system 300.

In Block 810, the identity of the user is detected. In one embodiment, the identity of the user is authenticated through the use of a password, a personal identification number, a biometric parameter, and the like.

In Block 820, the initial portions of multiple audio/visual content items are stored within the client device 320. In one embodiment, the specific audio/visual content items are selected, in part, by the preferences of the user as described above with reference to Block 720. In another embodiment, the selected audio/visual content represents audio/visual content that will more likely be chosen by the user than other audio/visual content.

In Block 830, a user selection for a particular audio/visual content item is detected.

In Block 840, an entire segment of the particular audio/visual content item is streamed into the client device 320. In one embodiment, the particular audio/visual content item is transmitted to the client device 320 from the media server 310.

In Block 850, the initial portion of the particular audio/visual content item that was stored within the temporary storage cache 330 is streamed to the stream synchronizer 340 immediately after the user selection in the Block 830. In one embodiment, the initial portion is made available as the resultant stream to the user via the stream synchronizer 340 while the entire segment of the particular audio/visual content transmitted to the client device 320 in the Block 840.

By making the resultant stream (comprised of the initial stream) available to the user while the entire segment is transmitted to the client device 320, the user is able to begin utilizing the particular audio/visual content item with minimal lag time.

In Block 860, a synchronization occurs when the resultant stream is transitioned from the initial portion to the entire segment. For example, in some instances the resultant stream containing the initial portion is presented to the user. At some point prior to the termination of the initial portion, the entire segment is seamlessly integrated into the resultant stream and presented to the user. In many instances, from a user's experience, the transition from utilizing the initial portion to the entire segment of the particular audio/visual content is seamless.

1. A method comprising:
identifying a preference;
selecting a content item based on the preference;
storing an initial portion of the content item in a temporary storage cache;
receiving a request for the content item;
streaming the initial portion of the content item from the temporary storage cache to a stream synchronizer in response to the request;
producing a resultant stream using the initial portion of the content item; and
seamlessly transitioning the resultant stream from the initial portion of the content item to an entire segment of the content item.

2. The method according to claim 1, wherein the preference is associated with a user.

3. The method according to claim 1, wherein the preference includes a playlist.

4. The method according to claim 1, wherein the resultant stream mirrors the entire segment of the content.

5. The method according to claim 1, further comprising identifying a user associated with the preference.

6. The method according to claim 1, wherein the content includes one of a document, an image, audio data, and video data.

7. The method according to claim 1, further comprising transmitting the entire segment of the content to a stream buffer in response to the request.

8. The method according to claim 7, wherein the transmitting the entire segment of the content occurs simultaneously with streaming the initial portion.

9. The method according to claim 1, wherein the seamlessly transitioning occurs in real-time.

10. The method according to claim 1, further comprising presenting the resultant stream beginning with the initial portion and subsequently followed by a portion of the entire segment.

11. A system comprising:
means for identifying a preference;
means for selecting a content item based on the preference;
means for storing an initial portion of the content item in a temporary storage cache;
means for receiving a request for the content item;
means for streaming the initial portion of the content item from the temporary storage cache to a stream synchronizer in response to the request;
means for producing a resultant stream using the initial portion of the content item; and
means for seamlessly transitioning the resultant stream from the initial portion of the content item to an entire segment of the content item.

12. A method comprising:
storing an initial portion a selected content item in a temporary storage cache;
streaming the initial portion of the selected content item from the temporary storage cache to a stream synchronizer;
simultaneously loading an entire segment of the selected content item to the stream synchronizer while streaming the initial portion;
producing a resultant stream comprising the initial portion of the selected content item; and
seamlessly transitioning the resultant stream from the initial portion of the content item to the entire segment of the content item.

13. The method according to claim 12, further comprising identifying a preference.

14. The method according to claim 13, wherein the content is selected from a plurality of content in response, in part, to the preference.

15. The method according to claim 12, wherein the transitioning occurs in real-time.

16. The method according to claim 12, further comprising requesting the content.

17. The method according to claim 12, wherein the content includes one of a document, an image, audio data, and video data.

18. The method according to claim 12, further comprising displaying the resultant stream.

19. A system comprising:
means for storing an initial portion a selected content item in a temporary storage cache;
means for streaming the initial portion of the selected content item from the temporary storage cache to a stream synchronizer;
means for simultaneously loading an entire segment of the selected content item to the stream synchronizer while streaming the initial portion;
means for producing a resultant stream comprising the initial portion of the selected content item; and
means for seamlessly transitioning the resultant stream from the initial portion of the content item to the entire segment of the content item.

20. A system comprising:
a media server configured for storing an entire segment of content;
a client device configured for storing an initial portion of the content wherein the client device is configured to display the content by streaming a resultant stream from the initial portion of the content while simultaneously receiving the entire segment of the content and seamlessly substituting the entire segment of the content for the initial portion.

21. The system according to claim 20, wherein the client device is configured to store the initial portion of the content prior to a request for the content.

22. The system according to claim 20, wherein the client device is configured to receive the entire segment subsequent to a request for the content.

23. The system according to claim 20, wherein the client device further comprises a preference data module configured for storing information relating to the content.

24. The system according to claim 20, wherein the client device further comprises a temporary storage cache configured for storing the initial portion of the content.

25. The system according to claim 20, wherein the client device further comprises a stream buffer configured for receiving the entire segment of the content.

26. The system according to claim 20, wherein the content includes one of a document, an image, audio data, and video data.
